(19) United States
(12) Patent Application Publication
(10) Pub. No.: US 2012/0130536 A1
(43) Pub. Date: May 24, 2012

(54) IMPLEMENTING SECURE, ANONYMOUS CUSTOMER INFORMATION EXCHANGE IN ONE OR MORE VENDING MACHINES THROUGH TOKENIZED CUSTOMER IDENTIFIERS GENERATED USING A ONE-WAY HASH FUNCTION

(75) Inventors: James M. Canter, Austin, TX (US); Bryan W. Godwin, Round Rock, TX (US)

(73) Assignee: CRANE MERCHANDISING SYSTEMS, INC., Bridgeton, MO (US)

(21) Appl. No.: 13/300,044

(22) Filed: Nov. 18, 2011

Related U.S. Application Data
(60) Provisional application No. 61/415,254, filed on Nov. 18, 2010.

(51) Int. Cl. G06F 17/00

(52) U.S. Cl. 700/237

(57) ABSTRACT

A unique, anonymous, tokenized customer identifier is derived by a one-way hash function from a credit/debit account number each time a customer provides the same credit/debit card information at a vending machine. The customer identifier thus repeatedly generated at each of the vending machines is then used to track the customer's purchase history and preferences for customer-focused programs, such as a loyalty rewards program. The customer need not carry a separate token bearing the customer identifier, but instead can automatically participate in the customer-focused programs as part of paying for a purchase. The customer may optionally remain anonymous in each program.

### CROSS-REFERENCE TO RELATED APPLICATION(S) AND CLAIM OF PRIORITY

This application claims the benefit of the filing date of commonly assigned U.S. Provisional Patent Application Ser. No. 61/415,254, filed Nov. 18, 2010 and titled “IMPLEMENTING SECURE, ANONYMOUS CUSTOMER LOYALTY PROGRAMS IN ONE OR MORE VENDING MACHINES THROUGH TOKENIZED CUSTOMER IDENTIFIERS GENERATED USING A ONE-WAY HASH FUNCTION”, which is hereby incorporated by reference.

### TECHNICAL FIELD

The present application relates generally to operating vending machines and, more specifically, to a method of anonymously identifying vending machine customers.

### BACKGROUND

Programs that require identification of customers, such as customer loyalty programs, are commonly employed by grocery stores, gas stations and many other retail enterprises. Normally such programs track customer purchases and offer benefits to the customer such as free or reduced-cost goods or services, often based on benchmarks for the customer's overall spending. The resulting accumulated information regarding customer spending and shopping preferences derived from such programs has independent value for the enterprise, and sales can often be spurred or accelerated by providing incentives to the identified customer to make additional purchase(s), provide feedback, or to make planned purchases in a manner benefiting the enterprise.

Like other types of retail enterprises, vending machine operators could benefit from implementation of programs that rely on the identification of the customer, as could producers of items commonly sold in vending machines (e.g., snack foods or beverages). However, many customers may be uncomfortable with revealing personal information, having their spending at vending machines tracked, or how the resulting purchase history might be exploited or abused. In addition, most customer loyalty programs utilize a rewards card and/or keychain tag or fob to store a unique customer identifier within a bar code or magnetic track thereon. Many customers may be unwilling to add yet another card or tag to their wallet or keychain to obtain benefits from vending machines.

There is, therefore, a need in the art for a secure method of identifying customers within vending machines in an anonymous manner that does not require a separate token (card, tag or fob) to store a unique customer identifier.

### SUMMARY

A method of providing anonymous customer identification at a vending machine is provided. The method includes obtaining a payment account number from a customer at the vending machine as part of a vend transaction. The method also includes generating a unique, tokenized customer identifier from the payment account number within the vending machine using a one-way hash function. The method further includes transmitting the customer identifier from the vending machine to a remote server. The method still further includes receiving at the vending machine a response associated with the customer identifier from the remote server. The method also includes completing the vend transaction at the vending machine based on the received response.

A device configured for use within a vending machine and capable of providing anonymous customer identification is provided. The device includes an interface configured to communicate with a remote server, and a controller. The controller is configured to obtain a payment account number from a customer at the vending machine as part of a vend transaction. The controller is also configured to generate a unique, tokenized customer identifier from the payment account number using a one-way hash function. The controller is further configured to transmit the customer identifier via the interface to the remote server. The controller is still further configured to receive a response associated with the customer identifier from the remote server. The controller is also configured to complete the vend transaction based on the received response.

A vending machine system is also provided. The vending machine system includes at least one vending machine configured to communicate with a remote server. The at least one vending machine includes a payment device configured to read a payment account number from a card, token, or electronic device associated with a customer, and a controller. The controller is configured to obtain a payment account number from a customer at the vending machine as part of a vend transaction, generate a unique, tokenized customer identifier from the payment account number using a one-way hash function, transmit the customer identifier to the remote server, receive a response associated with the customer identifier from the remote server, and complete the vend transaction based on the received response.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified perspective view illustrating a vending machine that may be used in connection with a customer identification method employing an anonymous, tokenized customer identifier according to one embodiment of the present disclosure;

FIG. 2 is a block diagram of a network for implementing a customer identification method employing an anonymous, tokenized customer identifier according to one embodiment of the present disclosure; and

FIG. 3 is a high level flow chart of a process for employing an anonymous, tokenized customer identifier as part of a customer loyalty rewards program according to one embodiment of the present disclosure.

### DETAILED DESCRIPTION

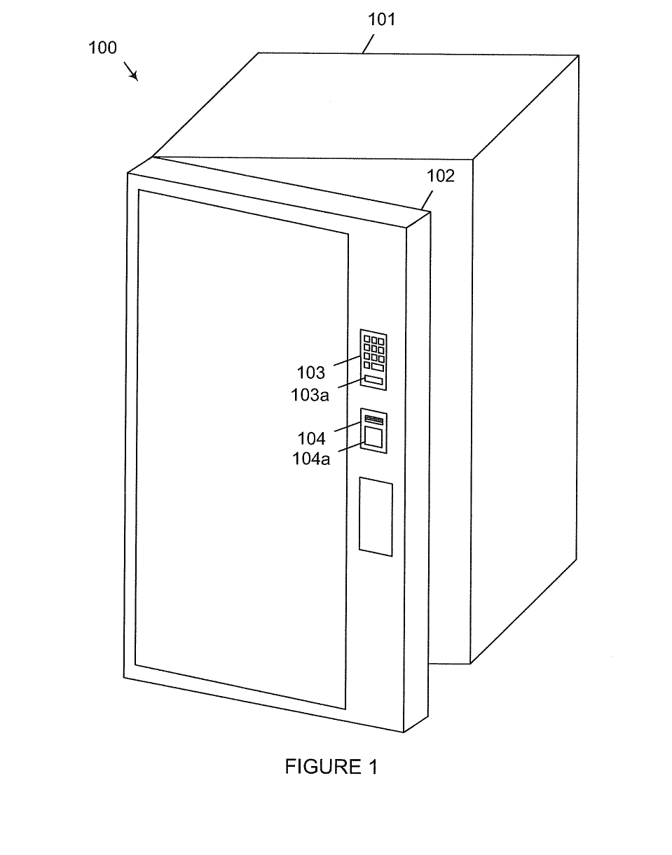

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine.

In accordance with this disclosure, a unique, anonymous, tokenized customer identifier is derived by a one-way hash function from a credit/debit account number each time a customer provides the credit/debit account number at a vending machine. The customer identifier thus repeatedly generated at each of the vending machines is then used to track the customer's purchase history and preferences. The tracked information can be used for a variety of purposes, including loyalty programs (by product brand or by vending machine operator), promotions, customer feedback or surveys, marketing, and so forth. The customer need not carry a separate token bearing the customer identifier, but instead can automatically participate by using the same credit/debit account for each vend transaction. The customer may optionally remain anonymous because no personal information other than the account number is received.

FIG. 1 is a simplified perspective view illustrating a vending machine 100 that may be used in connection with a customer identification method employing an anonymous, tokenized customer identifier according to one embodiment of the present disclosure. The vending machine 100 includes a cabinet 101 and a service door 102 that, together, define an enclosure. In the exemplary embodiment illustrated, the service door 102 is pivotally mounted to the front of the cabinet 101 and extends all the way across the front face of the vending machine 100. In alternate designs, the service door may extend only part way across the front of the vending machine, or may be formed in two portions (of equal or unequal sizes) that swing open in opposite directions.

In the exemplary embodiment illustrated in FIG. 1, the service door 102 includes a customer selection interface 103, illustrated as a keypad and light emitting diode (LED) display or liquid crystal display (LCD). However, the customer selection interface 103 may also employ a touchpad input device in addition to or in lieu of the keypad and display. Similarly, a payment system 104 is disposed within the service door 102 and includes one or more of a bill validator, a coin acceptor, a magnetic strip card payment processing device for credit and debit cards, and any other payment reader suitable for receiving payment information from a smart phone, personal electronic device, and the like. (Herein, “personal electronic device” refers to any device generally associated with an individual and capable of communicating data or information, such a mobile phone, iPad®, tablet computer, Bluetooth® device, RFID (radio frequency identification) fob, NFC (near field communication) device, and the like.)

The payment system 104 receives currency, coins, electronic payment cards, or other forms of payment from the customer and returns change as necessary. The payment system 104 may be configured to read a “swipe” of credit or debit cards. Additionally or alternatively, the payment system 104 may be configured for similar credit/debit payment methods such as RFID tags or contactless smart cards that are read by being “waved” at the payment mechanism. Either the payment system 104 or the vending machine 100 generally also includes at least one segment-based light emitting diode (LED) display, a liquid crystal display (LCD), or some other type of display device for displaying messages to the customer as described in further detail below.

Those skilled in the art will recognize that the full construction and operation of a vending machine is not depicted or described herein. Instead, only so much of a vending machine as is unique to the present disclosure or necessary for an understanding of the present disclosure is depicted and described. For example, some vending machines may have a large liquid crystal display instead of a glass front as depicted in FIG. 1, depicting products available during vending and displaying commercial messages between vends.

In addition, the subject matter of the present disclosure may be exploited without independently constructing a complete vending machine. Instead, the subject matter of the present disclosure may be embodied in devices intended for use within a vending machine, such as a device used to retrofit an existing vending machine for communication with a remote telemetry server and the like.

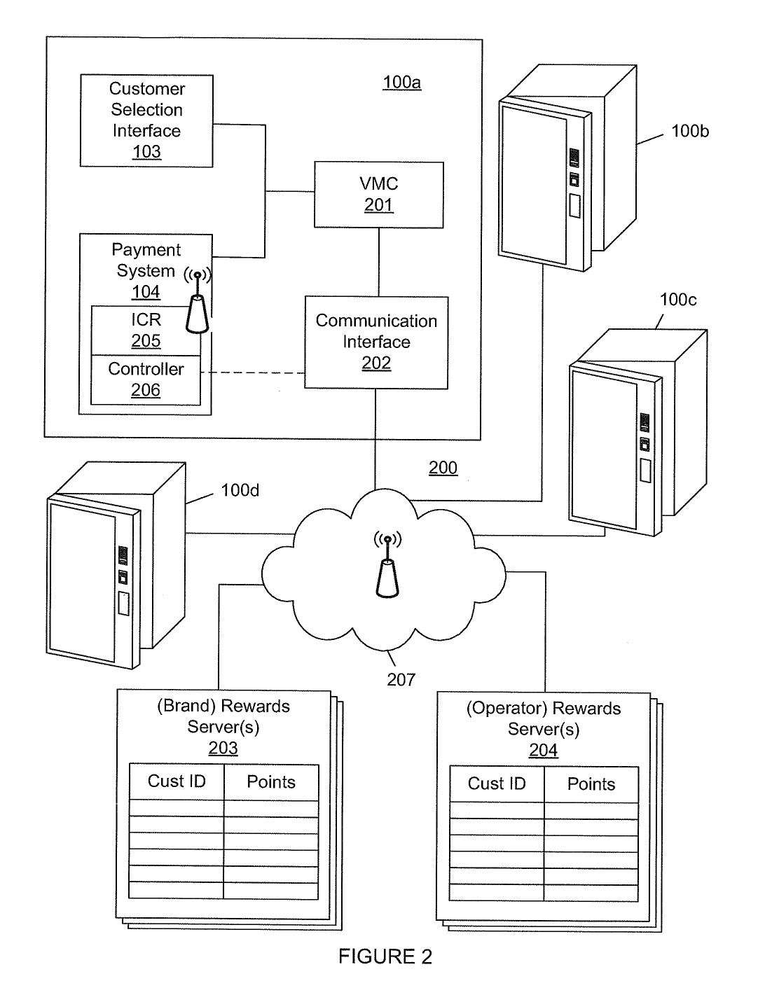

FIG. 2 is a block diagram of a network 200 implementing a customer identification method employing an anonymous, tokenized customer identifier, according to one embodiment of the present disclosure. The network 200 includes multiple instances 100a, 100b, 100c and 100d of the vending machine 100. While only four vending machines are depicted, the network 200 could include tens, hundreds, thousands or even tens of thousands of vending machines. The vending machines need not be identical, but may for instance include beverage vending machines as well as snack vending machines. The vending machines may all be operated by the same operator, or may be operated by two or more different operators.

The vending machine 100 includes electronics associated with the customer selection interface 103 and the payment system 104. In addition, the vending machine 100 includes a vending machine controller (VMC) 201 coupled to the customer selection interface 103 and the payment system 104. The vending machine 100 also includes a communication interface 202 coupling the VMC 201 to external, remote rewards server(s) 203 and 204.

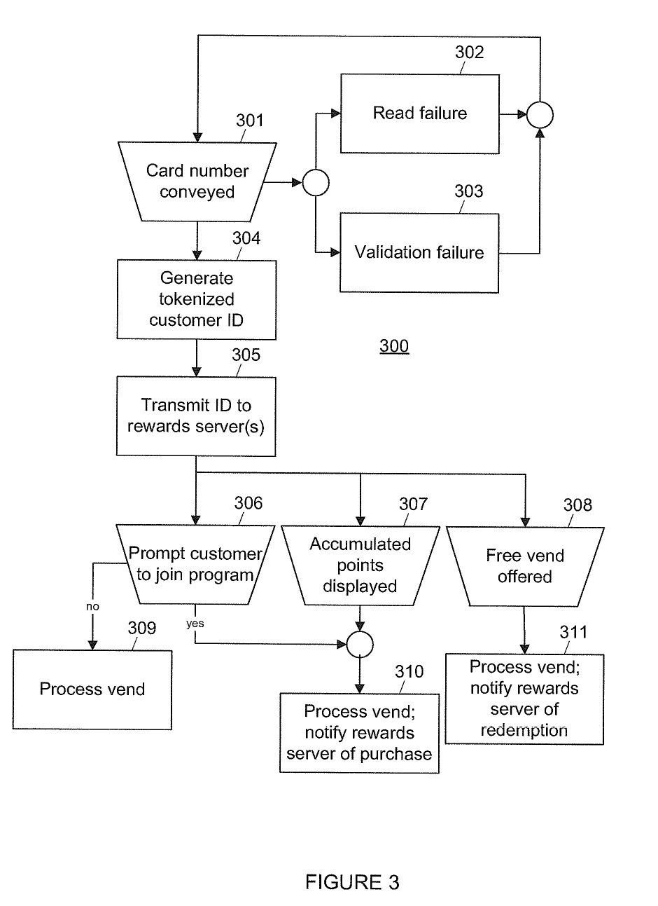

In one embodiment, the payment system 104 includes an interactive cashless reader (ICR) 205 and associated controller 206, which may be implemented in the manner of the cashless reader and audit device described in U.S. Patent Application Publications Nos. 2004/0133653 and 2007/0083287, the content of which is incorporated herein by reference. The ICR 205 and controller 206 preferably are configured to securely communicate with the rewards server(s) 203 and 204, either through the communication interface 202, through an independent wireless connectivity channel to a wide-area network (WAN) 207 enabled by components within the ICR 205 and controller 206, through a wired Ethernet connection, or more than one of these communication channels. In embodiments that utilize a WAN, the WAN may be “always on” or may establish ad hoc communications connectivity as needed, in the manner described in further detail below. Regardless, the communications channel(s) employed by the ICR 205 and controller 206 for the processes described in greater detail below in connection with FIGS. 2-3 are preferably secure (e.g., encrypted according to any of the standards promulgated by credit/debit card issuers).

In the exemplary embodiment, the ICR 205 includes a magnetic track card swipe device as described above. However, alternative designs may employ a wireless/contactless card or token reader as described above, either in addition to or in lieu of the swipe device. The ICR 205 and controller 206 may also communicate with the VMC 201 and other subsystems within or external to the vending machine 100 via a National Automatic Merchandising Association (NAMA) multi-drop bus (MDB), a Data Exchange (DEX) protocol communications channel, or both.

In an embodiment, other devices configured for installation within a vending machine and adapted for communication with the rewards server(s) 203 and 204, may implement the functionality described herein. For example, a telemetry unit coupled on a multi-drop bus (MDB) to a “legacy” VMC 201 to provide communication of product and/or currency inventories, sales, and operational information (e.g., status of a refrigeration unit in the vending machine) to a remote network operations center for the vending machine operator may implement the processes described in further detail below.

In another embodiment, the payment system 104 is fully integrated into the vending machine 100, such as found in CRANE MERCHANDISING SYSTEMS' BevMax-Media and Merchant-Media vending machines. That is, the payment system 104 is not an add-on component, but is integrated into the vending machine 100. In this embodiment, the payment system 104 includes the controller 206. The controller 206 is configured to communicate with the rewards server(s) 203 and 204, either through the communication interface 202, through an independent wide-area network (WAN) “always on” wired or wireless connectivity channel enabled by components within the controller 206, or both. The controller 206 may also communicate with the VMC 201 and other subsystems within or external to the vending machine 100 via a National Automatic Merchandising Association (NAMA) multi-drop bus (MDB), a Data Exchange (DEX) protocol communications channel, or both.

Although FIG. 2 illustrates one example of a network 200 that implements a customer identification method employing an anonymous, tokenized customer identifier, various changes may be made to FIG. 2. For example, while the servers 203 and 204 are described as reward servers, the servers 203 and 204 could represent any type of back-end server configured to employ an anonymous, tokenized customer identifier for promotions, customer feedback or surveys, marketing, or any other suitable purpose. Likewise, various other components could be combined, subdivided, or omitted and additional components could be added according to particular needs.

As previously described, one means for identifying a customer within the vending machines 100a-100d would employ a separate customer identification card (e.g., a rewards card) that would be swiped, tapped, or waved by the customer as part of every vend transaction. However, the need to carry around yet another rewards card is likely to be off-putting to many customers. In addition, to the extent that the customer is required to register the rewards card separately from any vend transaction, and to provide personal demographic information as part of such registration, the customer may be reluctant to participate in such rewards programs.

In the present disclosure, a unique customer identifier is formed for the customer as part of an ordinary cashless vend transaction, and may be used anonymously (i.e., without associating any personal identification information with the customer identifier) across multiple vend transactions at any vending machine employing the system of the present disclosure. During a typical (cashless) vend process, the customer normally conveys her credit/debit account number to the vending machine 100 before each transaction, such as by swiping her credit or debit card through the ICR 205, transmitting a code or payment token through a smart phone or another personal electronic device, entering a code on a touch screen on the vending machine, or through any other suitable mechanism. The account number is read from the card (e.g., by the ICR 205), and used to process payment in the manner known to those skilled in the relevant art. In addition, the credit/debit account number is also employed to generate a unique customer identifier for a customer rewards loyalty program.

Within the present disclosure, a unique “tokenized” customer identifier is derived in the controller 206 (or, alternatively, the VMC 201) from the customer's credit/debit account number using a one-way hash function, such as a salted hash, Message Digest version 4 or 5 (MD4, MD5), the Secure Hash Algorithm (SHA, including SHA-0, SHA-1, SHA-2 or future versions), or any other suitable hash function. The resulting hash value is secure, with no realistic possibility of deriving the customer's credit/debit account number from the unique hash value employed as the customer identifier. As additional security measures, however, only a portion of the customer's credit/debit account number may be used as the input for the hash function, digits within the credit/debit account number may be scrambled in a deterministic manner prior to application of the hash function, and/or other information readable from the credit/debit card (such as the first few letters of the customer's last name) may be employed as part of the input to the hash function.

The customer identifier is “tokenized” in that the value employed may be repeatedly derived at any vending machine from the same credit/debit account number using the hash function. The customer identifier is also “anonymous” in that no personally identifying information is intrinsically linked with the customer identifier. The irreversible (one-way) nature of the hash function effectively precludes determination of the credit/debit card account number from the customer identifier. Neither the account number itself nor any additional information scanned from the credit/debit card is sent by the vending machine to any other system as part of the identifier (the payment transaction is separately processed from the same information). Operations that utilize the customer identifier (e.g., a customer loyalty rewards program) may permit, but need not require, registration of the customer identifier to associate therewith either or both of personally identifying information (name, address or other contact information, date of birth, etc.) and generic demographic information (age, gender, general geographic place of residence, etc.). Such registration may be performed at a separate website using the credit/debit card account number, in a secure manner.

In the present disclosure, customers that wish to participate in a program such as a rewards program need not separately activate a program account number or customer identifier in order to participate in the program. Instead, the customer may automatically participate in the rewards program simply by conveying the same credit/debit account number (e.g., via a card swipe or touch) for each transaction. Each time the customer uses the same credit/debit account for a transaction at a vending machine 100a-100d participating in a particular customer-focused program, the same unique, tokenized and anonymous customer identifier is generated. Thus, the customer's payment at the vending machine itself provides the customer with access to the program(s).

A customer may participate in multiple customer-focused programs, such as consumer-based loyalty rewards programs offered by different brands and/or programs offered by a particular vending machine operator(s). The customer identifier derived from a credit/debit account number may thus be transmitted to multiple rewards servers 203-204 to add additional rewards points to an accumulated total and/or to check eligibility for a benefit. Rewards programs may be implemented across vending machines of different types (e.g., snack and beverage vending machines), allowing the customer to accumulate rewards points for different types of purchases at different types of vending machines.

In one embodiment, the controller 206 employs the same hash function on a credit/debit account number to generate the same tokenized customer identifier for all programs/functions/uses. In another embodiment, different hash functions (or variants of the same hash function) could be employed by the controller 206. By using different hash functions or variants of the same hash function (e.g., modifying the order in which digits of the credit/debit account number are scrambled before being input into the hash function), the controller 206 can derive different customer identifiers from the same credit/debit account number.

Thus, controller 206 is capable of using different hash functions and dynamically selecting a particular hash function for a particular purpose. In some embodiments, the requirements of each customer program or back end system may determine the selection of the hash function. For example, one rewards program may require that all customer identifiers be fifteen numeric digits in length. Another rewards program may require that customer numbers be twenty alphanumeric characters.

FIG. 3 is a high level flow chart of a process for employing an anonymous, tokenized customer identifier as part of a customer loyalty rewards program according to one embodiment of the present disclosure.

As shown in FIG. 3, the process 300 allows the customer's credit/debit account number to be used both for payment and to collect or redeem rewards points for the purchase, so that the customer is awarded a free or reduced-cost product for each predetermined number N or predetermined total dollar amount $X.00 of purchases at participating vending machines. The rewards points may be awarded for any purchase, only for purchase of products having the same brand(s), or only for purchases of specific products (e.g., a new soft drink). In addition, a different number of rewards points may be awarded for different types of purchases (soft drink versus snack food, etc.) or for different dollar amounts of purchases. Rewards points under multiple loyalty rewards programs may be awarded for the same purchase, or rewards programs may be mutually exclusive.

The process begins with a customer convey her credit card account number (step 301) (e.g., via card swipe or touch) at a vending machine with the payment system 104 that is participating in one or more rewards programs. The controller 206 reads the credit card number, for example: B3727 006992 51018^{Λ}AMEX TEST CARD^{Λ}2512990502700. (Notably, the VMC 201 may perform steps attributed to controller 206 in this description; however, increased security is achieved using a controller 206 within the payment system 104, and not transmitting the credit card number to the VMC 201).

Assuming that no read failure (step 302) or card number verification failure (step 303) occurs, the controller 206 then generates a unique, tokenized customer identifier (step 304) from the credit/debit account number using a one-way non-reversible hash, e.g., 4FGT674@#U*DFFG. This unique hash value is then transmitted (step 305) as an anonymous customer identifier to the rewards server(s) 203-204, preferably in a secure (i.e., encrypted) manner. The rewards server(s) 203-204 check the received customer identifier against previously recorded identifiers, to determine whether the corresponding credit/debit account number has previously been employed to join the respective rewards program (and, conversely, whether the customer has previously declined to join the rewards program).

If the customer's credit/debit account number has never before been employed to make a purchase at a vending machine participating in the respective rewards program, the server returns an appropriate response code and the vending machine prompts the customer to join the rewards program (step 306) on a display within the vending machine. If the customer's credit/debit account number has been employed for a prior vending machine purchase and the customer previously declined to join the rewards program, no further action need be taken (although, alternatively, the customer may be prompted again to join the rewards program). If the customer agrees to join the respective rewards program, the customer identifier is recorded at the rewards server 203 or 204 to establish an anonymous account. As described above, the customer may be given the option to personalize the account, or to associate anonymous demographic information with the account, by separate interaction. However, by default the rewards program account is created as an anonymous account.

If the received customer identifier matches an identifier already stored in the rewards server 203 or 204, the server determines whether the customer has previously accumulated sufficient rewards points to warrant a free vend and returns an appropriate response code. The vending machine then either displays accumulated points (step 307) and/or points still needed to earn another free vend, or offers the customer a free vend (step 308), as appropriate.

If the customer declines to join the rewards program (step 306), the vend transaction is processed without further interaction with the rewards server 203 or 204. Separately, and not directly related to the loyalty rewards program, the vending machine 100a also transmits information based on the credit/debit account number to a credit card processing service to authorize funds at a vending machine so the customer can make a selection. In response to the customer's selection, the vending machine vends the selected product.

If the customer agrees to join the rewards program, or has already joined the rewards program but has not yet accumulated sufficient points for a free vend, the vending machine displays accumulated points (step 307) or additional points required to earn a reward, and the payment and product delivery aspects of the vend transaction are processed (step 310) as described above. In addition, the vending machine notifies loyalty rewards server 203 or 204 that the customer, using customer identifier 4FGT674@#U*DFFG, made a purchase so that the rewards server can update the customer's accumulated rewards points. The vending machine may also transmit information regarding the product selection made by the customer (type and/or brand, using a unique product code), and/or the price paid by the customer. Such information may be tracked by rewards server 203 and 204, anonymously (by default).

The vending machine transmits no personally identifying information regarding the customer to the rewards server, just the anonymous, tokenized customer identifier. Likewise, the vending machine transmits no demographic information regarding the customer to the rewards server. The communications between the vending machine and the rewards server are completely anonymous. In addition, the customer was not required to separately register for the rewards program prior to initiating a vend transaction at the vending machine, or to present a separate token (card, tag or fob) at the vending machine. Instead, the customer's mere use of a credit or debit account was sufficient to automatically join and/or utilize the rewards program.

If the customer has previously agreed to join the rewards program and has accumulated sufficient points to earn a free vend, the free vend is offered to the customer (step 308) by the vending machine. The customer may be given the option to decline the free vend and instead pay for the selected product. However, if the free vend is accepted, the vending machine processes the payment and product delivery aspects of the vend transaction (step 311) in the manner described above. In addition, the vending machine notifies the reward servers 203 and 204 of the redemption by the customer so that the appropriate number of points may be deducted from the customer's loyalty account.

If the process 300 described above is employed by vending machine 100a for a customer's first use of the credit card resulting in hash value (and anonymous, tokenized customer identifier) 4FGT674@#U*DFFG and the customer joins the rewards program at that time, the next time the customer swipes the same credit card at a participating vending machine 100b, the process 300 is performed again. The same hash value 4FGT674@#U*DFFG is produced and transmitted to the rewards server(s) 203-204 in the second iteration of the process. The rewards server(s) 203 and/or 204 recognizes this hash value as a loyalty program customer identifier that was recorded from a past purchase, and the number of accumulated points is returned to the vending machine 100b, and additional points are accumulated for the customer's purchase, if any.

When the customer subsequently swipes the same credit card at any participating vending machine 100a-100d, the process 300 is repeated. The same anonymous, tokenized customer identifier 4FGT674@#U*DFFG is produced from the credit/debit account number and, if N purchases or $X.00 of purchases have been recorded in association with that customer identifier, the customer is offered a free vend.

Although FIG. 3 is described with respect to a loyalty rewards program, principles of the present disclosure could be employed for other types of customer interaction. For example, promotional messages may be dynamically generated based on a customer's previous purchase history, which is tracked via the customer identifier. As a specific example, if a customer regularly purchases one brand of chips, a dynamically generated message might suggest a different brand of chips to the customer. As yet another example, a dynamically generated message might request the customer to answer one or more survey questions about a product based on the customer's prior purchases. In such embodiments, the tokenized customer identifier may be associated in back end servers (e.g., servers 203 and 204) with the consumer's vend purchase history (including dates, locations, and items purchased), the consumer's eligibility for certain promotions, or any other suitable information.

The present disclosure combines a credit/debit card transaction at a vending machine with an automatically generated anonymous customer identifier. The unique one-way non-reversible hash function identifies the customer, and thus the customer need not carry a separate token bearing the customer identifier in order to participate in customer-focused programs, such as a rewards program. In addition, the customer may remain completely anonymous to each program while participating in the programs and receiving program benefits.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method of providing anonymous customer identification at a vending machine, comprising:
obtaining a payment account number from a customer at the vending machine as part of a vend transaction;
generating a unique, tokenized customer identifier from the payment account number within the vending machine using a one-way hash function;
transmitting the customer identifier from the vending machine to a remote server;
receiving at the vending machine a response associated with the customer identifier from the remote server; and
completing the vend transaction at the vending machine based on the received response.

2. The method of claim 1, wherein the remote server is a remote rewards server and the response is an indication of accumulated rewards points associated with the customer identifier in a reward program.

3. The method of claim 1, wherein the response is associated with a promotion or a survey and is customized for the customer based on the customer identifier.

4. The method of claim 1, wherein the customer identifier is transmitted from the vending machine to the remote server separately from any transmission of payment information from the vending machine to a payment server, and wherein no personally identifying information regarding the customer is transmitted from the vending machine to the remote server in connection with the vend transaction.

5. The method of claim 1, wherein the customer identifier is generated and transmitted by the vending machine without requiring the customer to present a token separate from a token containing the payment account number.

6. The method of claim 1, further comprising:
upon completing the vend transaction at the vending machine, transmitting information regarding the transaction from the vending machine to the remote server in association with the customer identifier, the information including one or more of an identification of a vended product and a price paid, if any, by the customer for the vended product.

7. The method of claim 1, wherein the vending machine is configured to use a plurality of different one-way hash functions, the method further comprising:
dynamically selecting a particular one-way hash function based on a requirement associated with the remote server.

8. A system configured to provide anonymous customer identification at a vending machine, the system comprising:
a first interface within the vending machine configured to receive payment account number from a payment token presented at the vending machine;
a second interface within the vending machine configured to communicate with a remote server; and
a controller communicably coupled to the first and second interfaces, the controller configured to:
obtain a payment account number from a customer via the first interface as part of a vend transaction;
generate a unique, tokenized customer identifier from the payment account number using a one-way hash function;
transmit the customer identifier via the second interface to the remote server;
receive a response associated with the customer identifier from the remote server; and
complete the vend transaction based on the received response.

9. The system of claim 8, wherein the remote server is a remote rewards server and the response is an indication of accumulated rewards points associated with the customer identifier in a reward program.

10. The system of claim 8, wherein the response is associated with a promotion or a survey and is customized for the customer based on the customer identifier.

11. The system of claim 8, wherein the controller transmits the customer identifier to the remote server separately from any transmission of payment information from the controller to a payment server, and wherein no personally identifying information regarding the customer is transmitted from the controller to the remote server in connection with the vend transaction.

12. The system of claim 8, wherein the controller generates and transmits the customer identifier without requiring the customer to present a token separate from a token containing the payment account number.

13. The system of claim 8, the controller is further configured to transmit, upon completion of the vend transaction at the vending machine, information regarding the transaction to the remote server in association with the customer identifier, the information including one or more of an identification of a vended product and a price paid, if any, by the customer for the vended product.

14. The system of claim 8, wherein the controller is capable of using a plurality of different one-way hash functions, and is configured to dynamically select a particular one-way hash function based on a requirement associated with the remote server.

15. A vending machine including the system of claim 8, the vending machine further comprising:
a vending machine controller configured to control the vend transaction; and
a payment device configured to read the payment account number from a card, token, or electronic device associated with the customer.

16. A vending machine system comprising:
at least one vending machine configured to communicate with a remote server, the at least one vending machine comprising:
a payment device configured to read a payment account number from a card, token, or electronic device associated with a customer; and
a controller configured to:
obtain a payment account number from a customer at the vending machine as part of a vend transaction;
generate a unique, tokenized customer identifier from the payment account number using a one-way hash function;
transmit the customer identifier to the remote server;
receive a response associated with the customer identifier from the remote server; and
complete the vend transaction based on the received response.

17. The vending machine system of claim 16, wherein the remote server is a remote rewards server and the response is an indication of accumulated rewards points associated with the customer identifier in a reward program.

18. The vending machine system of claim 16, wherein the response is associated with a promotion or a survey and is customized for the customer based on the customer identifier.

19. The vending machine system of claim 16, wherein the controller transmits the customer identifier to the remote server separately from any transmission of payment information to a payment server, and wherein no personally identifying information regarding the customer is transmitted from the controller to the remote server in connection with the vend transaction.

20. The vending machine system of claim 16, wherein the controller generates and transmits the customer identifier without requiring the customer to present a token separate from a token containing the payment account number.
